(19) United States
(12) Patent Application Publication
(10) Pub. No.: US 2020/0216228 A1
(43) Pub. Date: Jul. 9, 2020

(54) EARPHONE BOX AND CONTROL METHOD THEREOF

(71) Applicant: GOERTEK INC., Shandong Province (CN)

(72) Inventors: Jiyuan WANG, Shandong Province (CN); Yuge ZHU, Shandong Province (CN); Tianrong DAI, Shandong Province (CN); Hongmei WANG, Shandong Province (US); Huijin CHEN, Shandong Province (CN); Xuemin OU, Shandong Province (CN)

(73) Assignee: GOERTEK INC., Shandong Province (CN)

(21) Appl. No.: 16/624,737

(22) PCT Filed: May 21, 2019
(86) PCT No.: PCT/CN2019/087673

§ 371 Date: Dec. 19, 2019

(30) Foreign Application Priority Data
Jun. 5, 2018 (CN) 201810569334.9
Jun. 5, 2018 (CN) 201820862502.9

(51) Int. Cl. B65D 43/16; B65D 25/04; H04R 1/10

(52) U.S. Cl. CPC B65D 43/16; B65D 25/04; H04R 2460/17; H04R 1/1025; H04R 1/1041

(57) ABSTRACT

Discloses an earphone box and a control method thereof. The earphone box comprises a box body and a box cover, the box body is for containing an earphone and is connected to the box cover through a rotating shaft, and the box cover is rotatable relative to the box body and capable of being stabilized in a state of forming an angle with respect to the box body. The box body is provided therein with an angle detector which is capable of detecting a rotation angle of the rotating shaft and outputting a detected signal. The box body is further provided therein with an earphone box processor. The earphone box processor receives the detected signal, and when determining that a detected angle value indicated by the detected signal matches a preset angle value, outputs an operation instruction corresponding to the matched preset angle value.

### CROSS REFERENCE TO RELATED APPLICATIONS

This application is a U.S. National Stage entry under 35 U.S.C. § 371 based on International Application No. PCT/CN2019/087673, filed on May 21, 2019, which claims priority to Chinese Patent Application No. 201810569334.9 and Chinese Patent Application No. 201820862502.9, both filed on Jun. 5, 2018. The priority applications are hereby incorporated herein in their entirety by reference.

### TECHNICAL FIELD

This application pertains to the technical field of smart terminals, and in particular, to an earphone box and a control method thereof.

### BACKGROUND

At present, people have accustomed to using the wireless earphone to listen to the audio in the mobile intelligent terminal and make a call. However, the earphone storage box used to store the earphone has not been able to interchange information with the mobile intelligent terminal yet, and the user has to perform an operation, for example, manually match the earphone with the mobile intelligent terminal. Thus the intelligence level of the earphone storage box is relatively low. In addition, in the prior art, the earphone storage box also has the problem that the opening/closing state detection is inaccurate and it cannot be stabilized in the designated opening/closing state, which restricts the rapid development of the earphone storage box and affects the user experience. In addition, other objects, desirable features and characteristics will become apparent from the subsequent summary and detailed description, and the appended claims, taken in conjunction with the accompanying drawings and this background.

### SUMMARY

The present disclosure provides an earphone box and a control method thereof, which solves the problems in the prior art that the intelligence level of the earphone box is low, the opening/closing state detection is inaccurate, and it cannot be stabilized in the designated opening/closing state, and thus improves the user experience.

According to an aspect of the present disclosure, an earphone box is provided. The earphone box comprises a box body and a box cover, the box body is for containing an earphone and is connected to the box cover through a rotating shaft, and the box cover is rotatable relative to the box body and capable of being stabilized in a state of forming an angle with respect to the box body;

the box body is provided therein with an angle detector which is capable of detecting a rotation angle of the rotating shaft and outputting a detected signal;

the box body is further provided therein with an earphone box processor;

the earphone box processor receives the detected signal, and when determining that a detected angle value indicated by the detected signal matches a preset angle value, outputs an operation instruction corresponding to the matched preset angle value.

According to another aspect of the present disclosure, an earphone box is provided. The earphone box comprises a box body and a box cover;

the box body is for containing an earphone, and is provided therein with a left cavity and a right cavity which are symmetrical about the central line of the box body and are for receiving the earphone;

the box body is connected to the box cover through a rotating shaft, and the box cover is rotatable relative to the box body and capable of being stabilized in a state of forming an angle with respect to the box body;

the box body is provided therein with an angle detector which is capable of detecting a rotation angle of the rotating shaft and outputting a signal;

the box body is further provided therein with an earphone box processor;

the earphone box processor receives the signal of the angle detector, and when determining that a detected angle value indicated by the signal of the angle detector matches a preset angle value, outputs an operation instruction corresponding to the matched angle value.

According to still another aspect of the present disclosure, a method for controlling an earphone box is provided, the earphone box comprising a box body and a box cover, the box body and the box cover being connected through a rotating shaft, and the box body being provided therein with an angle detector, wherein

when the box cover is rotated relative to the box body, detecting a rotation angle of the rotating shaft to obtain a detected angle value;

comparing the detected angle value with preset angle values, and when the detected angle value matches a preset angle value, outputting an operation instruction corresponding to the matched preset angle value.

In the earphone box of the embodiments of the present disclosure, the box cover can be rotated relative to the box body and can be stabilized in a state of forming an angle with respect to the box body, which solves the problem that the earphone box cannot be stabilized in the designated opening/closing state. Moreover, the earphone box can output an operation instruction according to the rotation angle of the rotating shaft, that is, can output corresponding operation instructions according to different rotation states of the box cover to complete corresponding functions and operations, which simplifies the user's own operation and improves the intelligence level of the earphone box. Meanwhile, multi-instruction automatic output is realized in detecting the rotation angle of the box cover, so that the working process of the earphone box is accurate and stable. The method for controlling an earphone box of the embodiments can detect the rotation angle of the rotating shaft to determine the opening/closing state of the box cover, and further output different operation instructions according to different opening/closing states of the box cover, thereby conveniently completing the corresponding operations, saving the operation steps and time of the user, and thus improving the user experience.

### BRIEF DESCRIPTION OF DRAWINGS

The present invention will hereinafter be described in conjunction with the following drawing figures, wherein like numerals denote like elements, and:

FIG. 1 is a schematic structural view of an earphone box according to an embodiment of the present disclosure;

FIG. 2 is an enlarged view of a connecting portion of a box cover and a box body shown in FIG. 1;

FIG. 3 is a partial cross-sectional view of a state of the earphone box in which the box cover is closed according to an embodiment of the present disclosure;

FIG. 4 is an enlarged schematic view of a part of the structure of FIG. 3;

FIG. 5 is a partial cross-sectional view a state of the earphone box in which the box cover is fully opened according to an embodiment of the present disclosure;

FIG. 6 is an enlarged schematic view of a part of the structure of FIG. 5;

FIG. 7 is a schematic view of a part of the internal structure of the box body of the earphone box according to an embodiment of the present disclosure.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

It should be noted that the embodiments described below are merely some but not all of embodiments of the present disclosure. All other embodiments obtained by those skilled in the art based on the embodiments of the present disclosure without paying any creative efforts shall fall within the protection scope of the present disclosure.

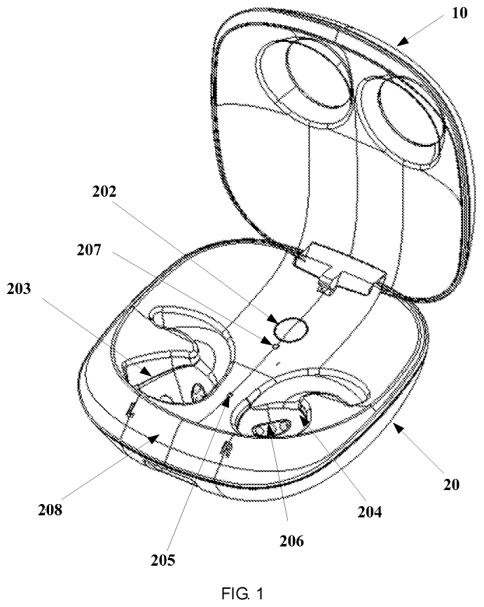

FIG. 1 is a schematic structural view of an earphone box according to an embodiment of the present disclosure. Referring to FIG. 1, the earphone box comprises a box body 20 and a box cover 10. The box body 20 is for containing an earphone, and the box body 20 is connected to the box cover 10 through a rotating shaft. The box cover 10 is rotatable relative to the box body 20 and can be stabilized in a state of forming an angle with respect to the box body 20.

The box body 20 is provided therein with an angle detector which is capable of detecting a rotation angle of the rotating shaft and outputting a detected signal.

The box body 20 is further provided therein with an earphone box processor. The earphone box processor receives the detected signal, and when determining that a detected angle value indicated by the detected signal matches a preset angle value, outputs an operation instruction corresponding to the matched preset angle value.

As shown in FIG. 1, in the earphone box according to the present embodiment, the box cover and the box body are connected through a rotating shaft, the box cover is rotatable relative to the box body, the box body is provided therein with the angle detector to detect the rotation angle of the rotating shaft, and when determining that a detected angle value indicated by the detected signal matches a preset angle value, the earphone box processor outputs an operation instruction corresponding to the matched preset angle value. That is, according to the present embodiment, corresponding operation instructions are outputted according to different rotation positions of the box cover to automatically complete some operations, thereby improving the intelligence level of the earphone box and the user's experience. Meanwhile, multi-instruction automatic output is realized in detecting the rotation angle of the box cover, so that the working process of the earphone box is accurate and stable.

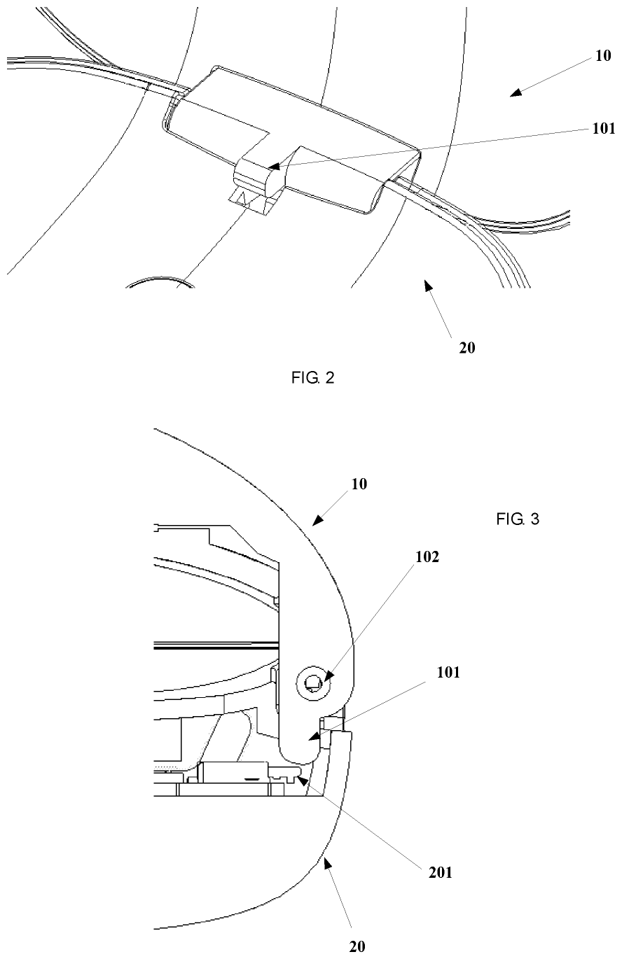

FIG. 2 is an enlarged view of the connecting portion of the box cover and the box body shown in FIG. 1. Referring to FIG. 2, the box cover 10 is provided with a bump 101, and the angle detector comprises a touch switch disposed in the box body and corresponding to the bump 101. When the box cover 10 is rotated relative to the box body 20, the bump 101 can trigger the touch switch to complete the detection of the rotation angle of the rotating shaft.

Considering the structure and space of the earphone box and the detection of the rotation angle of the rotating shaft, the present embodiment provides a solution in which a touch switch is arranged on the box body, and a bump is arranged on the box cover to engage with the bump. The structure is simple. Furthermore, two sides of the bump may be rounded (see the rounded corners on two sides of the bump in FIG. 2). Since the bump is to be rotated (such as, in opening the box cover), this design can avoid the interference between the bump and the casing when the bump is rotated, and makes the opening and closing of the earphone box easier; moreover, the gap between the bump and the casing is small, which can effectively prevent the dust from entering the circuit board in the box body and make its use safe.

In an embodiment of the present disclosure, two preferred types of implementation of detecting the rotation angle of the rotating shaft by an angle detector are provided. Namely, the touch switch may be a toggle switch or a roller switch.

In one type of implementation, the angle detector comprises a plurality of toggle switches disposed in the box body, and the plurality of toggle switches can engage with a plurality of bumps disposed on the box cover respectively. When the box cover is rotated to the closed position, the fully opened position, and a position between the closed position and the fully open position, the corresponding bump on the box cover triggers the corresponding toggle switch on the box body to complete the detection of the rotation angle of the rotating shaft.

The toggle switch turns on or turns off the circuit through a toggle switch handle. In this type of implementation, a plurality of toggle switches, such as a first toggle switch, a second toggle switch and a third toggle switch, are provided in the box body, and the plurality of toggle switches engage with a plurality of bumps disposed on the box cover respectively, so that the rotation angle of the rotating shaft can be determined by the difference of the switches triggered. Specifically, the toggle switches are arranged on a circuit board (see the circuit board shown in FIG. 7) in the box body, and the bumps are arranged on the surface of the connection portion of the box cover connected to the rotating shaft with an angle formed between every two bumps. It should be noted that, FIG. 2 and FIG. 3 schematically disclose that one bump 101 is disposed on the box cover 10 and one toggle switch 201 is disposed in the box body 20. When the bump 101 is rotated to the closed position and the fully open position, different triggering is performed on the toggle switch 201 to enable detection of different rotation angles of the rotating shaft. Based on the same principle, in order to realize the detection of a plurality of rotation angles, the bumps may be arranged on the surface of the connection portion of the box cover connected to the rotating shaft, and an angle is formed between every two bumps. The design with the toggle switch simplifies the assembly, and since the toggle switch has high reliability, this type of implementation has the merits such as simple and compact structure, convenient assembly, flexible switch, and more stable and reliable performance.

In the other type of implementation, the angle detector comprises a roller switch disposed in the box body, and the roller switch can engage with a plurality of bumps disposed on the box cover respectively. When the box cover is rotated to the closed position, the fully opened position, and a position between the closed position and the fully open position, the corresponding bump on the box cover triggers the roller switch to complete the detection of the rotation angle of the rotating shaft.

In this type of implementation, a roller switch is disposed in the box body, and the angle detection is completed by the engagement between the bumps and the roller switch. When a structure of roller switch is used, a gear shifting effect is generated when the bumps are in contact with the roller switch, so that the rolling feel of the roller can be clearly sensed, the resistance is small, the operation is smooth, the touch effect of the gear position is obvious, thereby making the adjustment of the rotating state of the box cover more accurate and comfortable, and improving the performance of the earphone box.

Therefore, the roller switch or the toggle switch may be selected as needed in actual use, which is not limited herein.

It should be noted that in the present embodiment, the closed position refers to a position where the angle between the box cover and the box body is 0 degrees. When the box cover is rotated to the closed position, the box cover can cover the opening of the box body to hide the earphone in the box body. The fully open position refers to a position where the angle between the box cover and the box body is a preset right angle or a preset obtuse angle. At the fully open position the box body is exposed so that the user can take the earphone out from the box body or relocate the earphone in the box body. A position between the closed position and the fully open position refers to a position where the angle between the box cover and the box body is a preset acute angle. In order to distinguish the positions, the position between the closed position and the fully open position is referred to herein as a half open position. It can be understood that when the box cover is rotated to the half open position, the angle between the box cover and the box body may be 60 degrees, and may also be 45 degrees, which is not limited herein.

The structure of the earphone box of the present embodiment will be described below by taking the implementation that the angle detector uses the toggle switch as an example.

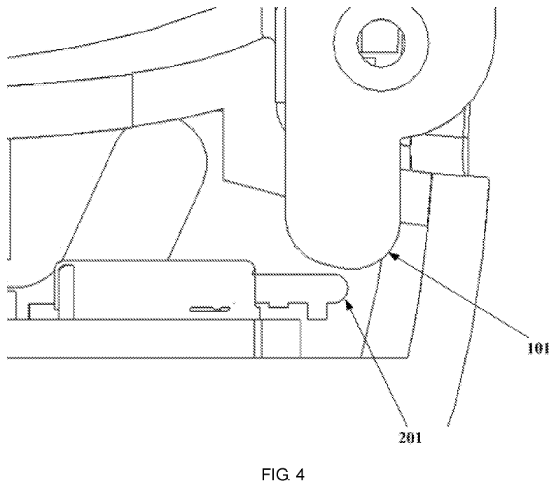

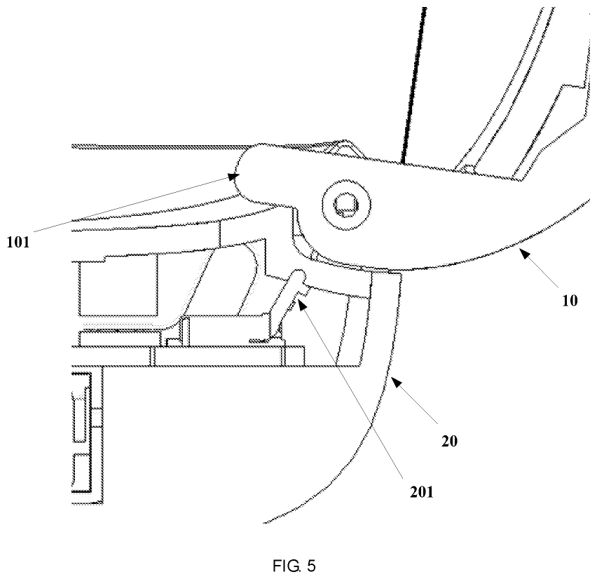

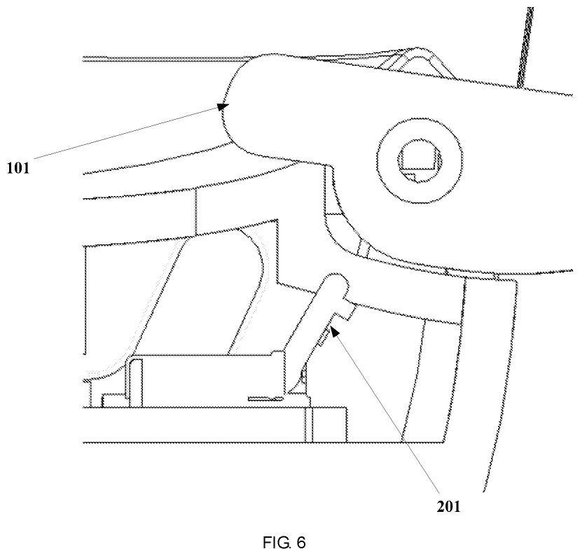

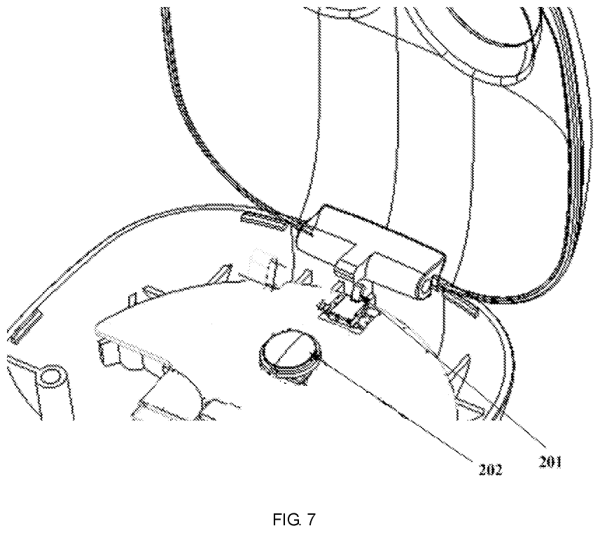

Referring to FIG. 3 to FIG. 6, FIG. 3 and FIG. 4 illustrate the engagement of the toggle switch with the bump when the box cover is rotated to the closed position, and FIG. 5 and FIG. 6 illustrate the engagement of the toggle switch with the bump when the box cover is rotated to the fully open position.

In the present embodiment, the box cover and the box body are connected through a rotating shaft, and the box cover can be rotated relative to the box body and can be stabilized in a state of forming an angle with respect to the box body. First, it is explained that the box cover moves and stabilizes at the closed position corresponding to the state of forming an angle of 0 degrees with respect to the box body.

Referring to FIG. 3 and FIG. 4, a bump 101 is disposed below the shaft hole 102 in the box cover 10. Below the bump 101 is a toggle switch 201 disposed on the box body 20. The bump 101 is close to the toggle switch 201. After the earphone has been used by the user and placed in the earphone box, the box cover is rotated to the closed position. At the closed position, the bump 101 triggers the toggle switch to enter an “on” state, and outputs, a first signal indicating that the box cover is closed, to the earphone box processor on the circuit board, and the earphone box processor determines the current rotation angle of the rotating shaft and the position to which the box cover is rotated (i.e., the closed position) according to the received first signal of the toggle switch.

In addition, in order to achieve a stable state of the box cover at the closed position, in the present embodiment, a magnetic fixing member is disposed at an end of the box body away from the rotating shaft (the position shown by 208 in FIG. 1). The magnetic fixing member attracts and fixes the box cover when the box cover is rotated to the closed position. The magnetic fixing member is, for example, a magnet.

Next, it is explained that the box cover moves and stabilizes at the fully open position corresponding to the state of forming a right angle or an obtuse angle with respect to the box body. At the fully open position, the opening of the box body for receiving the earphone is exposed so that the user can take the earphone out from the box body or relocate the earphone in the box body. Referring to FIG. 5 and FIG. 6, the bump 101 on the box cover 10 is away from the toggle switch 201 on the box body 20. The bump 101 triggers the toggle switch 201 to enter a second state, such as an “off” state, after the box cover is rotated to the fully open position. The toggle switch 201 sends, a second signal indicating that the box cover is rotated to the fully open position, to the earphone box processor on the circuit board in the box body, and the earphone box processor determines that the box cover is rotated to the fully open position according to the second signal.

Finally, it is explained that the box cover moves and stabilizes at a position between the closed position and the fully open position as stated above.

Different from the above embodiment, the detection of the box cover being rotated to the half-open position is realized as follows. Three bumps are provided on the box cover with an angle formed between every two bumps, and correspondingly, three toggle switches are provided on the box body. Here, as an example, it is explained that a first toggle switch engages with a first bump, a second toggle switch engages with a second bump, and a third toggle switch engages with a third bump.

When the box cover is rotated to the closed position, the first bump triggers the first toggle switch to enter a first state (the first state is a valid state), and a signal indicating being closed is output to the earphone box processor.

When the box cover is rotated to the fully open position, the third bump triggers the third toggle switch to enter the first state and a signal indicating being fully opened is output to the earphone box processor.

When the box cover is rotated to the half open position, the second bump located between the first bump and the third bump triggers the second toggle switch to enter the first state, and a signal indicating being half opened is output to the earphone box processor. At this point, the earphone box processor can determine that the box cover is rotated to the half open position according to the signal indicating being half opened.

It should be noted that since the three toggle switches are arranged side by side on the surface of the connecting portion of the box cover and an angle is formed between every two toggle switches, there is one and only one bump triggers and engages with one and only one toggle switch on the box body when the box cover is rotated to a specific position, thereby completing the detection of the rotation angle of the rotating shaft.

Further, in an embodiment of the present disclosure, in order to solve the problem that the state of the box cover may be unstable at the half-open position and tend to be attracted to the closed position, the rotating shaft connecting the box cover and the box body is designed to be a regular prism (such as a regular hexagonal prism) having a radial cross section of a regular polygon, the radial cross section of the shaft hole in the box cover for mounting the rotating shaft and the radial cross section of the rotating shaft are the same regular polygon, and a slit is provided on the wall of the shaft hole so as to stabilize the box cover in the state of forming an acute angle with respect to the box body. By designing both the rotating shaft and the shaft hole to be a regular polygon, the rotation angle can be accurate, and the box cover can be reliably positioned at the desired angular orientation.

In an embodiment of the present disclosure, a charging circuit is provided on the circuit board in the box body to charge the battery of the earphone contained in the box body. Referring to FIG. 1, a battery indicator 207 and a pairing button 202 are disposed in the central position of the box body 10 at the end where the rotating shaft is disposed. Since the plane of the opening of the box body as shown in FIG. 1 is approximately square, so the central position is the position where the center line of the box body is located. The battery indicator 207 indicates the electricity quantity of the battery of the earphone. The pairing button 202 is operable to place the earphone in a pairing mode.

In fact, in other embodiments, the box body 20 may include one or more battery indicators 207 which can indicate the electricity quantity of the battery of the earphone box and/or the battery of the earphone so that the user can view these indicators on the outer surface of the box body, thereby meeting the user's requirement to know the electricity quantity in time.

In some embodiments, the battery indicator 207 may include a plurality of LED lights, such as three LED lights, one for indicating the status of the battery of the earphone box, and the other two for indicating the status of the battery of each of the earphones. In addition, the battery indicator 207 may be a first color (for example, green) when the corresponding battery is near full charge, a second color (for example, yellow) when the electricity quantity of the corresponding battery is less than a specified threshold, and a third color (for example, red) when there is no electrical charge or a limited electrical charge.

The pairing button 202 is configured to receive an instruction input by the user pressing the pairing button, and notify the earphone box processor to control the earphone to enter the pairing mode via the interface. In an embodiment, the earphone must be in the box body when entering the pairing mode, and in other embodiments, the earphone may not have to be in the box body and only needs to be within a wireless communication distance of the box, thereby meeting the diverse use requirements of the user.

In an embodiment of the present disclosure, an earphone box is further provided. The earphone box comprises a box body and a box cover. The box body is for containing the earphone, and is provided therein with a left cavity and a right cavity which are symmetrical about the central line of the box body and are for receiving the earphone. The box body is connected to the box cover through a rotating shaft, the box cover is rotatable relative to the box body and can be stabilized in a state of forming an angle with respect to the box body. The box body is provided therein with an angle detector capable of detecting the rotation angle of the rotating shaft and outputting a signal. The box body is further provided therein with an earphone box processor. The earphone box processor receives the signal of the angle detector, and when determining that a detected angle value indicated by the signal of the angle detector matches a preset angle value, outputs an operation instruction corresponding to the matched angle value.

Referring to FIG. 1, in the present embodiment, the cavity for containing an earphone is disposed in the box body 20 and comprises a left cavity 203 and a right cavity 204, each cavity being sized and shaped to receive one earphone. The cavities (203, 204) are provided therein with a contact group 206 capable of being electrically connected to the earphone. The contact group 206 comprises a charging contact for charging the earphone through the earphone box and a communication contact for data transmission between the earphone box and the earphone contained in the box body. The design of the data contact and the communication contact realize the independent completion of data transmission and power transmission, and improve the stability and efficiency of data and power transmission.

In an embodiment, the contact group 206 may include three contacts, among which a pair of contacts is for charging the earphones in the earphone box and the other contact is for data transmission between the earphone box and the earphones, such as, for sending control commands to the earphone from the earphone box. The contacts herein may be Pogo Pin connectors. With the design that a contact group comprises three Pogo Pin connectors, it is beneficial to improve the utilization of the Pogo Pin connector, the current and signal can be transmitted through the Pogo Pin connector, the structure is firm, it is easy to install, the cost is low, and the service life is long.

Moreover, the earphone box of the present embodiment is provided with a left cavity and a right cavity, and the left cavity and the right cavity are symmetrical with respect to the central line of the box body and are for receiving the left earphone and the right earphone respectively. The left cavity and the right cavity can be distinguished by an identifier, for example, a letter L corresponding to the left cavity, and a letter R corresponding to the right cavity, which is convenient for the user to recognize and place the earphones in the corresponding cavity, thereby facilitating the storage of the earphone.

Referring to FIG. 1, the earphone box of the present embodiment further comprises a reset button 205 and it is configured that the earphone box processor controls the earphone to generate a reset signal when receiving a trigger command from the user, which solves the problem that the earphone cannot be reset when an abnormality occurs. For example, when the earphone cover is opened, the reset button is exposed; after receiving a user's pressing operation instruction, the earphone box processor connected with the reset button controls the earphone to reset according to the operation instruction of the user, whether the earphone is in the earphone box or not.

The present disclosure further provides a method for controlling an earphone box, the earphone box comprises a box body and a box cover, the box body and the box cover are connected through a rotating shaft, and the box body is provided therein with an angle detector. The method for controlling an earphone box comprises:

when the box cover is rotated relative to the box body, a rotation angle of the rotating shaft is detected to obtain a detected angle value;

the detected angle value is compared with preset angle values, and when the detected angle value matches a preset angle value, an operation instruction corresponding to the matched preset angle value is output.

In an embodiment, the preset angle values comprises a first angle value indicating that the box cover is rotated to form a closed state with respect to the box body, a second angle value indicating that the box cover is rotated to form an acute angle with respect to the box body, and a third angle value indicating that the box cover is rotated to form a fully open state with respect to the box body;

the step of comparing the detected angle value with preset angle values, and when the detected angle value matches a preset angle value, outputting an operation instruction corresponding to the matched preset angle value specifically comprises:

when the detected angle value matches the first angle value, a corresponding operation instruction for stopping to pair with the mobile smart terminal is output;

when the detected angle value matches the second angle value, a corresponding operation instruction for starting to pair with the mobile smart terminal is output; and

when the detected angle value matches the third angle value, a corresponding operation instruction, for controlling the mobile smart terminal to output a pop-up window prompt, is output.

Furthermore, the method for the present embodiment further comprises: a bump is provided on the box cover, and a touch switch corresponding to the bump is provided in the box body; and

the detection of the rotation angle of the rotating shaft is completed by triggering the touch switch by the bump when the box cover is rotated relative to the box body.

Furthermore, the method for the present embodiment further comprises:

a plurality of bumps are provided on the box cover and a plurality of toggle switches are provided in the box body, the plurality of toggle switches are able to engage with the plurality of bumps respectively; and the detection of the rotation angle of the rotating shaft is completed by triggering a corresponding toggle switch on the box body by a corresponding bump on the box cover when the box cover is rotated to a closed position, a fully open position, and a position between the closed position and the fully open position; or

a plurality of bumps are provided on the box cover and a roller switch is provided in the box body, the roller switch is able to engage with the plurality of bumps; and the detection of the rotation angle of the rotating shaft is completed by triggering the roller switch by a corresponding bump on the box cover when the box cover is rotated to a closed position, a fully open position, and a position between the closed position and the fully open position.

The specific implementation of each step of the method of the present embodiment may be referred to the related description in the above embodiments of product, which will not be repeated herein.

As stated above, the method for controlling an earphone box of the present embodiment can not only accurately detect the rotation position of the box cover, but also can realize different control operations according to different rotation positions of the box cover, thereby greatly improving the intelligence level of the earphone box. For example, when it is detected that the box cover is at the closed position, a corresponding operation instruction for stopping to pair with the mobile smart terminal is outputted to the earphone, the earphone is controlled to stop the pairing with the mobile smart terminal (such as a smart phone), so as to finish the signal transmission between them and save power of the earphone. For example, when it is detected that the box cover of the earphone box is at the half open position, a corresponding operation instruction for starting to pair with the mobile smart terminal is outputted to the earphone, the earphone is controlled to start and establish the pairing with the mobile smart terminal (such as a smart phone). Compared with the solution of the prior art in which the user must turn on the pairing switch of the earphone to complete the pairing, the user's operation steps can be reduced; moreover, the pairing with the mobile smart terminal can be established before the user takes out the earphone to wear which saves the user's time. For another example, when it is detected that the box cover moves and stabilizes at the fully open position, a corresponding operation instruction for controlling the mobile smart terminal (such as a smart phone) to output a pop-up window prompt is outputted. The operation instruction for controlling the mobile smart terminal to output a pop-up window prompt may be to control a smart phone to output a pop-up window, and the pop-up window prompts the user with the model, name, electricity quantity and other information of the current earphone, so that the user can conveniently learn the information of the earphone connected with the user's mobile phone, and the safety of the pairing is improved.

It should be noted that the terms “comprises”, “comprising” or any other variants are intended to encompass a non-exclusive inclusion, such that a process, method, article, or device that includes a plurality of elements comprises not only those elements but also other elements not specifically listed, or elements that are inherent to such a process, method, article, or device. An element that is defined by the phrase “comprising a . . . ” does not exclude the presence of additional equivalent elements in the process, method, article, or device that comprises the element.

The above description is merely specific embodiments of the present disclosure. Based on the above teachings of the present disclosure, those skilled in the art may make other improvements or modifications on the basis of the foregoing embodiments. It should be understood by those skilled in the art that the above specific description is only for better explaining the present disclosure, and the protection scope of the present disclosure should be determined by the protection scope of the claims.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. An earphone box, wherein
the earphone box comprises a box body and a box cover, the box body is for containing an earphone and is connected to the box cover through a rotating shaft, and the box cover is rotatable relative to the box body and capable of being stabilized in a state of forming an angle with respect to the box body;
the box body is provided therein with an angle detector which is capable of detecting a rotation angle of the rotating shaft and outputting a detected signal;
the box body is further provided therein with an earphone box processor;
the earphone box processor receives the detected signal, and when determining that a detected angle value indicated by the detected signal matches a preset angle value, outputs an operation instruction corresponding to the matched preset angle value.

2. The earphone box according to claim 1, wherein the box cover is provided with a bump, the angle detector comprises a touch switch disposed in the box body and corresponding to the bump, and when the box cover is rotated relative to the box body, the bump is capable of triggering the touch switch to complete the detection of the rotation angle of the rotating shaft.

3. The earphone box according to claim 2, wherein two sides of the bump are rounded.

4. The earphone box according to claim 2, wherein the angle detector comprises a plurality of toggle switches disposed in the box body which are capable of engaging with a plurality of bumps disposed on the box cover respectively, and when the box cover is rotated to a closed position, a fully open position, and a position between the closed position and the fully open position, a corresponding bump on the box cover triggers a corresponding toggle switch on the box body to complete the detection of the rotation angle of the rotating shaft.

5. The earphone box according to claim 4, wherein under a situation in which the box cover is rotated to a position between the closed position and the fully open position,
three bumps are provided on the box cover with an angle formed between every two bumps, and three toggle switches are provided on the box body among which a first toggle switch engages with a first bump, a second toggle switch engages with a second bump, and a third toggle switch engages with a third bump;
when the box cover is rotated to the closed position, the first bump triggers the first toggle switch and a signal indicating being closed is output to the earphone box processor;
when the box cover is rotated to the fully open position, the third bump triggers the third toggle switch and a signal indicating being fully opened is output to the earphone box processor; and
when the box cover is rotated to a half open position, the second bump located between the first bump and the third bump triggers the second toggle switch and a signal indicating being half opened is output to the earphone box processor.

6. The earphone box according to claim 4, wherein there is one and only one bump triggers and engages with the one and only one toggle switch on the box body when the box cover is rotated to a specific position.

7. The earphone box according to claim 2, wherein the angle detector comprises a roller switch disposed in the box body, and the roller switch is capable of engaging with a plurality of bumps disposed on the box cover;
when the box cover is rotated to a closed position, a fully opened position, and a position between the closed position and the fully open position, a corresponding bump on the box cover triggers the roller switch to complete the detection of the rotation angle of the rotating shaft.

8. The earphone box according to claim 4, wherein the toggle switches are arranged on a circuit board in the box body, and the bumps are arranged on a surface of a connection portion of the box cover connected to the rotating shaft with an angle formed between every two bumps.

9. The earphone box according to claim 1, wherein a magnetic fixing member is disposed at an end of the box body away from the rotating shaft, and the magnetic fixing member attracts and fixes the box cover when the box cover is rotated to the closed position.

10. The earphone box according to claim 1, wherein
a charging circuit is provided on a circuit board in the box body to charge a battery of the earphone contained in the box body; and
a battery indicator and a pairing button are disposed in a central position of the box body at an end where the rotating shaft is disposed, the battery indicator indicates an electricity quantity of the battery of the earphone, and the pairing button is operable to place the earphone in a pairing mode.

11. The earphone box according to claim 1, wherein
the box body is further provided therein with a cavity for containing the earphone;
the cavity is provided therein with a contact group capable of being electrically connected with the earphone;
the contact group comprises a charging contact and a communication contact;
the charging contact is for charging the earphone through the earphone box, and the communication contact is for data transmission between the earphone box and the earphone contained in the box body.

12. The earphone box according to claim 1, wherein the rotating shaft is a regular prism having a radial cross section of a regular polygon, the radial cross section of the shaft hole in the box cover for mounting the rotating shaft and the radial cross section of the rotating shaft are the same regular polygon, and a slit is provided on a wall of the shaft hole so as to stabilize the box cover in the state of forming an acute angle with respect to the box body.

13. An earphone box, wherein
the earphone box comprises a box body and a box cover;
the box body is for containing an earphone, and is provided therein with a left cavity and a right cavity which are symmetrical about the central line of the box body and are for receiving the earphone;
the box body is connected to the box cover through a rotating shaft, and the box cover is rotatable relative to the box body and capable of being stabilized in a state of forming an angle with respect to the box body;
the box body is provided therein with an angle detector which is capable of detecting a rotation angle of the rotating shaft and outputting a signal;
the box body is further provided therein with an earphone box processor;
the earphone box processor receives the signal of the angle detector, and when determining that a detected angle value indicated by the signal of the angle detector matches a preset angle value, outputs an operation instruction corresponding to the matched angle value.

14. The earphone box according to claim 13, wherein
the preset angle values comprises a first angle value indicating that the box cover is rotated to form a closed state with respect to the box body, a second angle value indicating that the box cover is rotated to form an acute angle with respect to the box body, and a third angle value indicating that the box cover is rotated to a fully open state with respect to the box body;
the earphone box processor is specially configured to: when the detected angle value matches the first angle value, output a corresponding operation instruction for stopping to pair with the mobile smart terminal; when the detected angle value matches the second angle value, output a corresponding operation instruction for starting to pair with the mobile smart terminal; when the detected angle value matches the third angle value, output a corresponding operation instruction for controlling the mobile smart terminal to output a pop-up window prompt.

15. A method for controlling an earphone box, the earphone box comprising a box body and a box cover, the box body and the box cover being connected through a rotating shaft, and the box body being provided therein with an angle detector, wherein
when the box cover is rotated relative to the box body, detecting a rotation angle of the rotating shaft to obtain a detected angle value;
comparing the detected angle value with preset angle values, and when the detected angle value matches a preset angle value, outputting an operation instruction corresponding to the matched preset angle value.

16. The method according to claim 15, wherein the preset angle values comprises a first angle value indicating that the box cover is rotated to form a closed state with respect to the box body, a second angle value indicating that the box cover is rotated to form an acute angle with respect to the box body, and a third angle value indicating that the box cover is rotated to form a fully open state with respect to the box body;
the step of comparing the detected angle value with preset angle values, and when the detected angle value matches a preset angle value, outputting an operation instruction corresponding to the matched preset angle value comprises:
when the detected angle value matches the first angle value, outputting a corresponding operation instruction for stopping to pair with the mobile smart terminal;
when the detected angle value matches the second angle value, outputting a corresponding operation instruction for starting to pair with the mobile smart terminal; and
when the detected angle value matches the third angle value, outputting a corresponding operation instruction for controlling the mobile smart terminal to output a pop-up window prompt.

17. The method according to claim 15, wherein
providing a bump on the box cover, and providing a touch switch corresponding to the bump in the box body; and
completing the detection of the rotation angle of the rotating shaft by triggering the touch switch by the bump when the box cover is rotated relative to the box body.

18. The method according to claim 15, wherein
providing a plurality of bumps on the box cover and a plurality of toggle switches in the box body, the plurality of toggle switches being engageable with the plurality of bumps respectively; and completing the detection of the rotation angle of the rotating shaft by triggering a corresponding toggle switch on the box body by a corresponding bump on the box cover when the box cover is rotated to a closed position, a fully open position, and a position between the closed position and the fully open position; or
providing a plurality of bumps on the box cover and a roller switch in the box body, the roller switch being engageable with the plurality of bumps; and completing the detection of the rotation angle of the rotating shaft by triggering the roller switch by a corresponding bump on the box cover when the box cover is rotated to a closed position, a fully open position, and a position between the closed position and the fully open position.
